(19) United States
(12) Patent Application Publication
(10) Pub. No.: US 2018/0018555 A1
(43) Pub. Date: Jan. 18, 2018

(54) SYSTEM AND METHOD FOR BUILDING ARTIFICIAL NEURAL NETWORK ARCHITECTURES

(71) Applicants: Alexander Sheung Lai WONG, Waterloo (CA); Mohammad Javad SHAFIEE, Waterloo (CA)

(72) Inventors: Alexander Sheung Lai WONG, Waterloo (CA); Mohammad Javad SHAFIEE, Waterloo (CA)

(21) Appl. No.: 15/429,470

(22) Filed: Feb. 10, 2017

Related U.S. Application Data
(60) Provisional application No. 62/362,834, filed on Jul. 15, 2016.

(51) Int. Cl. G06N 3/04; G06N 3/08; G06F 7/58

(52) U.S. Cl. CPC G06N 3/04; G06F 7/58; G06N 3/08

(57) ABSTRACT

There is disclosed a novel system and method for building artificial neural networks for a given task. In an embodiment, the method utilizes one or more network models that define the probabilities of nodes and/or interconnects, and/or the probabilities of groups of nodes and/or interconnects, from sets of possible nodes and interconnects existing in a given artificial neural network. These network models can be constructed based on the properties of one or more artificial neural networks, or constructed based on desired architecture properties. These network models are then used to build combined network models using a model combiner module. The combined network models and random numbers generated by a random number generator module are then used to build one or more new artificial neural network architectures. New artificial neural networks are then built based on the newly built artificial neural network architectures and are trained for a given task. These trained artificial neural networks can then be used to generate network models for building subsequent artificial neural network architectures. This iterative building process can be repeated in order to learn how to build new artificial neural network architectures, and this learning may be stored to build future artificial neural network architectures based on past neural network architectures.

### FIELD OF THE INVENTION

The present disclosure relates generally to the field of artificial neural networks, and more specifically to systems and methods for building artificial neural networks.

### BACKGROUND

Artificial neural networks are node-based systems that are able to process samples of data to generate an output for a given input, and learn from observations of the data samples to adapt or change. Artificial neural networks typically consists of a group of nodes (neurons) and interconnects (synapses). Artificial neural networks may be embodied in hardware in the form of an integrated circuit chip or on a computer.

One of the biggest challenges in artificial neural networks is in designing and building artificial neural networks that meet the needs and requirements, and provide optimal performance for different tasks (e.g., speech recognition on a low-power mobile phone, object recognition on a high performance computer, event and activity recognition on a low-energy, lower-cost video camera, low-cost robots, genome analysis on a supercomputer cluster, etc.).

Heretofore, the complexity of designing artificial neural networks often required human experts to design and build these artificial neural networks by hand to determine the network architecture of nodes and interconnects. The artificial neural network was then optimized through trial-and-error, based on experience of the human designer, and/or use of computationally expensive hyper-parameter optimization strategies. This optimization of artificial network architecture is particularly important when embodying the artificial neural network as integrated circuit chips, since reducing the number of interconnects can reduce power consumption and cost and reduce memory size, and may increase chip speed. As such, the building and testing of neural networks is very time-consuming, and requires significant human design input.

What is needed is an improved system and method for building artificial neural networks which addresses at least some of these limitations in the prior art.

### SUMMARY

The present disclosure relates generally to the field of artificial neural networks, and more specifically to systems and methods for building artificial neural networks.

In one aspect, the present method consists of one or more network models that define the probabilities of nodes and/or interconnects, and/or the probabilities of groups of nodes and/or interconnects, from sets of possible nodes and interconnects existing in an artificial neural network. These network models may be constructed based on the network architectures of one or more artificial neural networks, or alternatively constructed based on desired network architecture properties (e.g., the desired network architectural properties may be: a larger number of nodes and/or interconnects; a smaller number of nodes and/or interconnects; a larger number of nodes but smaller number of interconnects; a larger number of interconnects but smaller number of nodes; a larger number of nodes at certain layers, a larger number of interconnects at certain layers, increase or decrease in the number of layers, adapting to a different task or to different tasks, etc.).

In an embodiment, the network models are combined using a model combiner module to build combined network models. Using a random number generator and the combined network models, new artificial neural network architectures are then automatically built using a network architecture builder. New artificial neural networks are then built such that their artificial neural network architectures are the same as the automatically built neural network architectures, and are then trained.

In an iterative process, the artificial neural networks can then be used to generate network models for automatically building subsequent artificial neural network architectures. This iterative building process can be repeated in order to learn how to build new artificial neural network architectures, and this learning may be stored to build future artificial neural network architectures based on past neural network architectures.

Unlike prior methods for building new neural networks which required labor-intensive design by human experts and brute-force hyper-parameter optimization strategies to determine network architectures, the present method allows new artificial neural networks with desired network architectures to be built automatically with reduced human input, making it easier for artificial neural networks to be built for different tasks that meet different requirements and desired architectural properties, such as reducing the number of interconnects needed for integrated circuit embodiments to reduce energy consumption and cost and memory size, and increasing chip speed.

In an illustrative embodiment, the present system consists one or more network models defining the probabilities of nodes and/or interconnects, and/or the probabilities of nodes and/or interconnects, from sets of possible nodes and interconnects existing in an artificial neural network. One or more of these models may be constructed based on the properties of artificial neural networks, and/or one or more of these models may be constructed based on desired artificial neural network architecture properties.

In an embodiment, the system may further include a model combiner module adapted to combine one or more network models into combined network models.

In another embodiment, the system further includes a network architecture builder module that takes as inputs combined network models, and the output from a random number generator module adapted to generate random numbers. The network architecture builder module takes these inputs, and builds new artificial neural network architectures as the output. Based on these new artificial neural network architectures built by the neural network architecture builder module, the system builds one or more artificial neural networks optimized for different tasks, such that these artificial neural networks have the same artificial neural network architectures as these new artificial neural network architectures.

In another embodiment, the artificial neural networks built using the network architectures built by the neural network architecture builder module can then be used to generate network models for automatically building subsequent artificial neural network architectures. This iterative building process can be repeated in order to learn how to build new artificial neural network architectures, and this learning may be stored to build future artificial neural network architectures based on past neural network architectures.

In this respect, before explaining at least one embodiment of the invention in detail, it is to be understood that the invention is not limited in its application to the details of construction and to the arrangements of the components set forth in the following description or the examples provided therein, or illustrated in the drawings. Therefore, it will be appreciated that a number of variants and modifications can be made without departing from the teachings of the disclosure as a whole. Therefore, the present system, method and apparatus is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

As noted above, the present disclosure relates generally to the field of artificial neural networks, and more specifically to systems and methods for building artificial neural networks.

The present system and method will be better understood, and objects of the invention will become apparent, when consideration is given to the following detailed description thereof. Such description makes reference to the annexed drawings, wherein:

FIG. 1 shows a system in accordance with an illustrative embodiment, comprising one or more network models, a random number generator module, a network architecture builder module, and one or more neural networks.

FIG. 2 shows another illustrative embodiment in which the system is optimized for a task pertaining to object recognition and/or detection from images or videos, comprising of two network models, a random number generator module, a network architecture builder module, and one or more neural networks for a task pertaining to object recognition and/or detection from images or videos.

FIG. 3 shows a schematic block diagram of a generic computing device which may provide an operating environment for various embodiments.

FIGS. 4A and 4B show schematic block diagrams of illustrative integrated circuit with an unoptimized network architecture (FIG. 4A), and an integrated circuit embodiment with an optimized network architecture built in accordance with the present system and method (FIG. 4B).

In the drawings, embodiments are illustrated by way of example. It is to be expressly understood that the description and drawings are only for the purpose of illustration and as an aid to understanding, and are not intended as describing the accurate performance and behavior of the embodiments and a definition of the limits of the invention.

### DETAILED DESCRIPTION

As noted above, the present invention relates to a system and method for building artificial neural networks.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

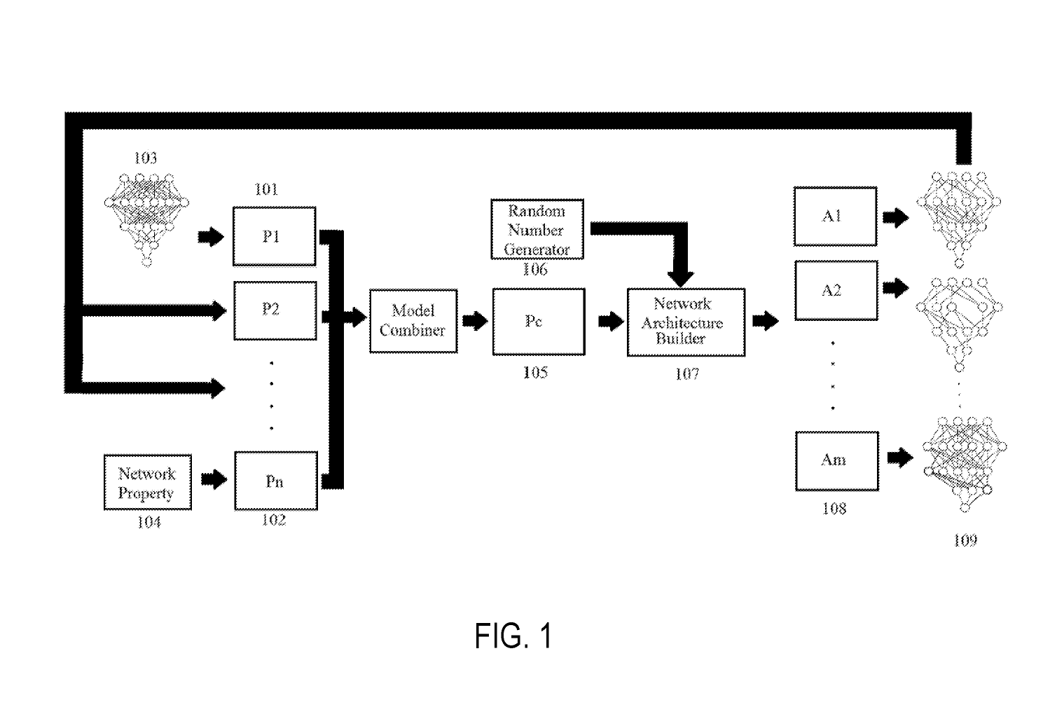

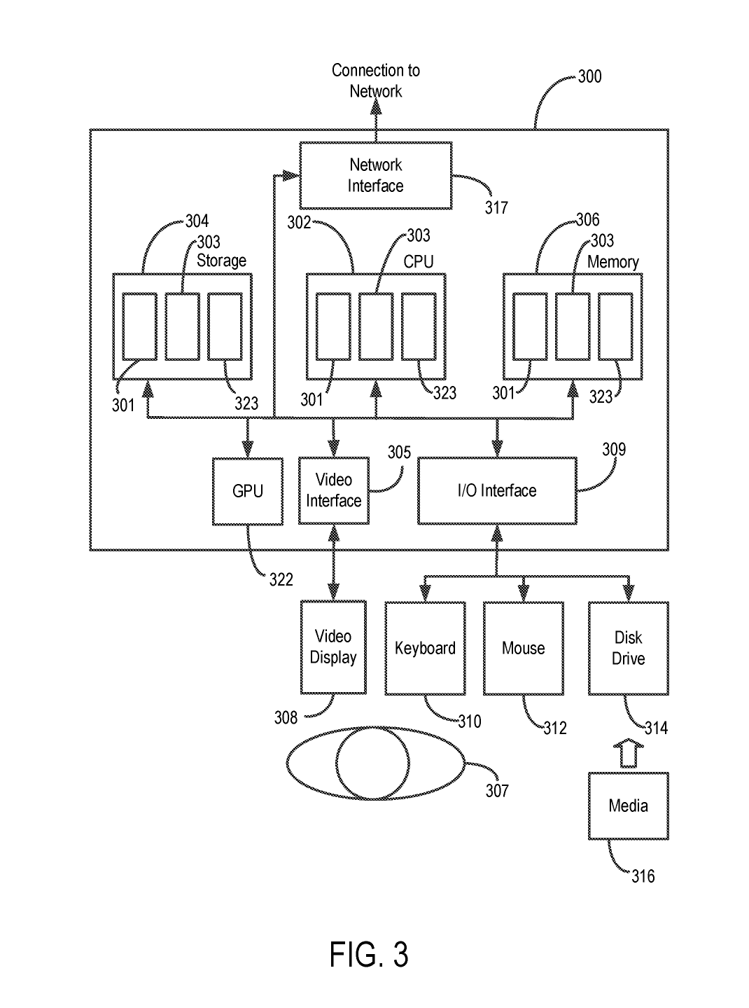

With reference to FIG. 1, shown is a system in accordance with an illustrative embodiment. In this example, the system comprises one or more network models 101, 102, a random number generator module 106, a network architecture builder module 107, and one or more neural networks 103, 109. The system may utilize a computing device, such as a generic computing device as described with reference to FIG. 3 (please see below), to perform these computations, and to store the results in memory or storage devices.

The one or more network models 101 and 102 are denoted by P1, P2, P3, . . . , Pn, where each network model defines the probabilities of nodes n_i and/or interconnects s_i, and/or the probabilities of groups of nodes and/or interconnects, from a set of all possible nodes N and a set of all possible interconnects S existing in an artificial neural network. These network models 101 and 102 can be constructed based on the properties of one or more neural networks 103. In an embodiment, the neural networks 103 may have different network architectures and/or designed to perform different tasks; for example, one neural network is designed for the task of recognizing faces while another neural network is designed for the task of recognizing vehicles. Other tasks that the neural networks 103 may be designed for include, but are not limited to, pedestrian recognition, bicycle recognition, region of interest recognition, facial expression recognition, emotion recognition, crowd recognition, speech recognition, handwriting recognition, language translation, image generation, disease detection, image captioning, food quality assessment, image colorization, and image quality assessment. In other embodiments, the neural networks may have the same network architecture and/or designed to perform the same task. In an illustrative embodiment, the network model can be constructed based on a set of interconnect weights W_T in an artificial neural network T:

P(N,S)∝W_T

where the probability of interconnect s_i existing in a given network is proportional to the interconnect weight w_i in the artificial neural network. In another illustrative embodiment, the network model can be constructed based on a set of nodes N_T in an artificial neural network T:

P(N,S)∝N_T

where the probability of node n_i existing in a given network is proportional to the existence of a node n_{T,i} in the artificial network. In another illustrative embodiment, the network model can be constructed based on a set of interconnect group weights Wg_T in an artificial neural network T:

P(N,S)∝Ng_T

where the probability of interconnect s_i existing in a given network is proportional to the aggregate interconnect weight of a group of interconnects g, denoted by wg_i, in the artificial neural network. In another illustrative embodiment, the network model can be constructed based on a set of node groups Ng_T in an artificial network T:

P(N,S)∝Ng_T

where the probability of node n_i existing in a given network is proportional to the existence of a group of nodes ng_{T,i} that n_i belongs to, in the artificial neural network. Note that other network models based on artificial networks may be used in other embodiments and the description of the above described illustrative network model is not meant to be limiting.

Still referring to FIG. 1, in another embodiment, the network models 101 and 102 can be constructed based on desired architecture properties 104 (e.g., larger number of nodes and/or interconnects; smaller number of nodes and/or interconnects; larger number of nodes but smaller number of interconnects; larger number of interconnects but smaller number of nodes; larger number of nodes at certain layers, larger number of interconnects at certain layers, increase or decrease in the number of layers, adapting to a different task or different tasks, etc.) For example, a smaller number of nodes and/or interconnects may be the desired architecture property to reduce the energy consumption and cost of integrated circuit chip embodiments of the artificial neural network.

In an illustrative embodiment, the network model can be constructed such that the probability of node n_i existing in a given network is equal to a desired node probability function D:

P(N,S)=D(N)

where a high value of D(n_i) results in a higher probability of node n_i existing in a given network, and a low value of D(n_i) results in a lower probability of node n_i existing in a given network. As such, the network model in this case is constructed based on a desired amount of nodes as well as the desired locations of nodes in the resulting architecture.

In another illustrative embodiment, the network model can be constructed such that the probability of interconnect s_i existing in a given network is equal to a desired interconnect probability function E:

P(N,S)=E(S)

where a high value of E(s_i) results in a higher probability of interconnect s_i existing in a given network, and a low value of E(s_i) results in a lower probability of interconnect s_i existing in a given network. As such, the network model in this case is constructed based on the desired amount of interconnects as well as the desired locations of the interconnects in the resulting architecture. Note that desired node probability function D and the desired interconnect probability function E can be combined to construct the network model P(N,S). Also note that in other embodiments, other network models based on other desired architecture properties may be used, and the illustrative network models described above are not meant to be limiting.

Still referring to FIG. 1, in another embodiment, the network models 101 and 102 are combined using a model combiner module to build combined network models P_c(N,S) 105.

As an illustrative example, in the model combiner module, a combined network model can be the weighted product of the network models 101 and 102:

P_c(N,S)=P1(N,S)̂q1×P2(N,S)̂q2×P3(N,S)̂q3× . . . ×Pn(N,S)̂qn

where q1, q2, q3, . . . qn are the weights on each network model, and ̂ denote an exponential function and × denote multiplication.

In another illustrative embodiment, a combined network model can be the weighted sum of the network models 101 and 102:

P_c(N,S)=q1×P1(N,S)+q2×P2(N,S)+q3×P3(N,S)+ . . . +qn×Pn(N,S)

Note that other methods of combining the network models into combined network models in the model combiner module may be used in other embodiments, and the illustrative methods for combining network models described above are not meant to be limiting.

Still referring to FIG. 1, in an embodiment, the system and method receives as inputs combined network models 105 along with a random number generator module 106 that generates random numbers. These inputs are processed by a network architecture builder module 107, which automatically builds new artificial neural network architectures A1, A2, . . . , Am 108.

In an illustrative embodiment, the network architecture builder module 107 performs the following operations for all nodes n_i in the set of possible nodes N to determine if each node n_i will exist in the new artificial neural network architecture Aj being built:
(1) Generate a random number U with the random number generator module
(2) If the probability of that particular node n_i as indicated in P_c(N,S) is greater than U, add n_i to the new artificial neural network architecture Aj being built.

The network architecture builder modules 107 also performs the following operations for all interconnects s_i in the set of possible interconnects S to determine if each interconnect s_i will exist in the new artificial neural network architecture Aj being built:
(3) Generate a random number U with the random number generator module
(4) If the probability of that particular interconnect s_i as indicated in P_c(N,S) is greater than U, add s_i to the new artificial neural network architecture Aj being built.

In an embodiment the random number generator module is adapted to generate uniformly distributed random numbers, but this is not meant to be limiting and other statistical distributions may be used in other embodiments.

After the above operations are performed by the neural network architecture builder module 107, all nodes and interconnects that are not connected to other nodes and interconnects in the built artificial neural network architecture Aj are removed from the artificial neural network architecture to obtain the final built artificial neural network architecture Aj. In an embodiment, this removal process is performed by propagating through the artificial neural network architecture Aj and marking the nodes and interconnects that are not connected to other nodes and interconnects in the built artificial neural network architecture Aj and then removing the marked nodes and interconnects, but this is not meant to be limiting and other methods for removal may be used in other embodiments.

Note that other methods of generating artificial neural network architectures based on network models and a random number generator module may be used in other embodiments, and the illustrative methods as described above are not meant to be limiting.

Still referring to FIG. 1, in an embodiment, based on the automatically built neural network architectures 108 from the network architecture builder module 107, new artificial neural networks 109 can then be built based on the automatically built neural network architectures 108 such that the artificial neural network architectures of these new artificial neural networks 109 are the same as the automatically built neural network architectures 108. In an embodiment, the new artificial neural networks 109 can then be trained by minimizing a cost function using optimization algorithms such as gradient descent and conjugate gradient in conjunction with artificial neural network training methods such as the back-propagation algorithm. Cost functions such as mean squared error, sum squared error, cross-entropy cost function, exponential cost function, Hellinger distance cost function, and Kullback-Leibler divergence cost function may be used for training artificial neural networks. The illustrative cost functions described above are not meant to be limiting. In an embodiment, the artificial neural networks 109 are trained based on the desired bit-rates of interconnect weights in the artificial neural networks, such as 32-bit floating point precision, 16-bit floating point precision, 32-bit fixed point precision, 8-bit integer precision, and 1-bit binary precision. For example, the artificial neural networks 109 may be trained such that the bitrate of interconnect weights are 1-bit integer precision to reduce hardware complexity and increase chip speed in integrated circuit chip embodiments of an artificial neural network. The illustrative optimization algorithms and artificial neural network training methods described above are also not meant to be limiting. The purpose of training the artificial neural networks is to produce artificial neural networks that are optimized for desired tasks.

After the artificial neural networks 109 are trained, all interconnects that have interconnect weights equal to 0 and all nodes that are not connected to other nodes and interconnects are removed from the artificial neural networks. In an embodiment, this removal process is performed by propagating through the artificial neural networks and marking interconnects that have interconnect weights equal to 0 and all nodes that are not connected to other nodes and interconnects and then removing the marked nodes and interconnects, but this is not meant to be limiting and other methods for removal may be used in other embodiments.

The new trained artificial neural networks can then be used to construct subsequent network models, which can then be used for automatically building subsequent artificial neural network architectures. This iterative building process can be repeated in order to learn how to build new artificial neural network architectures, and this learning may be stored to build future artificial neural network architectures based on past neural network architectures.

The artificial neural network architecture building process as described above can be repeated to build different artificial neural network architectures for different purposes, based on previous artificial neural network architectures.

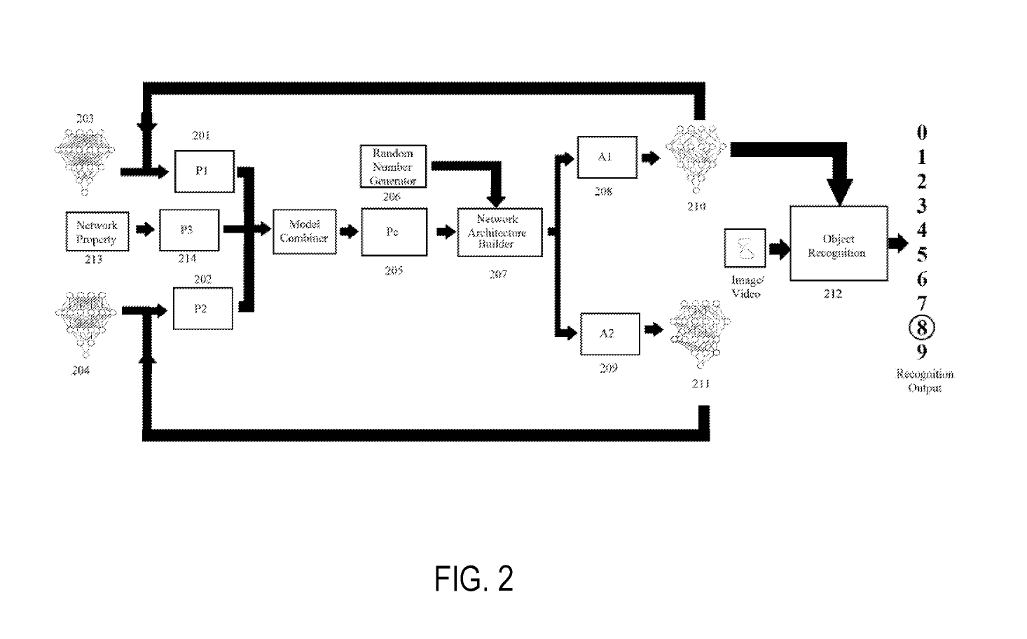

Now referring to FIG. 2, shown is another illustrative embodiment in which the system is optimized for a task pertaining to object recognition and/or detection from images or videos. In this example, the system comprises three network models 201, 202, 214, a random number generator module 206, a network architecture builder module 207, and one or more artificial neural networks 203, 204, 210, 211 for tasks pertaining to object recognition and/or detection from images or videos. Once again, the system may utilize a computing device, such as a generic computing device as described with reference to FIG. 3 (please see below), to perform these computations, and to store the results in memory or storage devices.

In an embodiment, the network models 201 and 202, denoted by P1 and P2 where each network model may be defined as the probabilities of nodes n_i and/or interconnects s_i, and/or the probabilities of groups of nodes and/or interconnects, from a set of all possible nodes N and a set of all possible interconnects S existing in an artificial neural network, may be constructed based on the properties of artificial neural networks trained on tasks pertaining to object recognition and/or detection from images or videos 203 and 204. In an embodiment, the artificial neural networks 203 and 204 may have different network architectures and/or designed to perform different tasks pertaining to object recognition and/or detection from images or videos; for example, one artificial neural network is designed for the task of recognizing faces while another artificial neural network is designed for the task of recognizing vehicles. Other tasks that the artificial neural networks 203 and 204 may be designed for include, but are not limited to, pedestrian recognition, bicycle recognition, region of interest recognition, facial expression recognition, emotion recognition, crowd recognition, speech recognition, handwriting recognition, language translation, image generation, disease detection, image captioning, food quality assessment, image colorization, and image quality assessment. In other embodiments, the artificial neural networks may have the same network architecture and/or designed to perform the same task. In an illustrative embodiment, the network model can be constructed based on a set of interconnect weights W_T in an artificial neural network T:

P(N,S)∝W_T

where the probability of interconnect s_i existing in a given network is proportional to the interconnect weight w_i in the artificial neural network. As an illustrative example, the network model may be constructed such that the probability of each interconnect s_i existing in a given network is equal to the sum of the corresponding normalized interconnect weight w_i in the artificial neural network, and a offset q_i:

P(s_i)=w_i+q_i

q_i is set to 0.05 in this specific embodiment but can be set to other values in other embodiments of the invention. In another illustrative embodiment, the network model can be constructed based on a set of nodes N_T in an artificial neural network T:

P(N,S)∝N_T

where the probability of node n_i existing in a given network is proportional to the existence of a node n_{T,i} in the artificial neural network. As an illustrative example, the probability of each node n_i existing in a given network is equal to the weighted sum of a node flag y_i (where y_i=1 if n_i exists in the artificial neural network, and y_i=0 if n_i does not exists in the artificial neural network), and a offset r_i:

P(n_i)=h_i×y_i+r_i

where h_i is set to 0.9 and r_i is set to 0.1 in this specific embodiment but can be set to other values in other embodiments of the invention. Note that other network models based on artificial neural networks may be used in other embodiments and the description of the above described illustrative network model is not meant to be limiting. The network model P(N,S) is constructed as a combination of P(s_i) and P(n_i) in this specific embodiment.

In another illustrative embodiment, the network model 214, denoted by P3 can also be constructed based on a desired network architecture property 213, such as: a larger number of nodes and/or interconnects; a smaller number of nodes and/or interconnects; a larger number of nodes but smaller number of interconnects; a larger number of interconnects but smaller number of nodes; a larger number of nodes at certain layers, a larger number of interconnects at certain layers; increase or decrease in the number of layers; adapting to a different task or to different tasks. For example, a smaller number of nodes and/or interconnects is a desired network architecture property to reduce the energy consumption and cost and memory size of an integrated circuit chip embodiment of the artificial neural network. In an illustrative example, the network model can be constructed such that the probability of interconnect s_i existing in a given network is equal to a desired interconnect probability function E:

P(N,S)=E(S)

where a high value of E(s_i) results in a higher probability of interconnect s_i existing in a given network, and a low value of E(s_i) results in a lower probability of interconnect s_i existing in a given network. In this specific embodiment E(s_i)=0.5 but can be set to other values in other embodiments of the invention. Note that in other embodiments, other network models based on other desired architecture properties may be used, and the illustrative network models described above are not meant to be limiting.

The network models 201, 202, 214 are then combined in the model combiner module to build a network model P_c(N,S) 205. As an illustrative embodiment, a combined network model can be the weighted product of the network models 201, 202, 214:

P_c(N,S)=P1(N,S)̂q1×P2(N,S)̂q2×P3(N,S)̂q3

where q1, q2, q3 are the weights on each network model, and ̂ denote an exponential function and × denote multiplication.

In another illustrative embodiment, a combined network model can be the weighted sum of the network models 201, 202, 214:

P_c(N,S)=q1×P1(N,S)+q2×P2(N,S)+q3×P3(N,S)

In this illustrative example, the combined network model is a function of the network models 201, 202, 214 as follows:

P_c(N,S)=(q1×P1(N,S)+q2×P2(N,S))×P3(N,S)̂q3

where q1 is set to 0.5, q2 is set to 0.5, and q3 is set to 1 for all nodes and interconnects for this specific embodiment but can be set to other values in other embodiments of the invention. Note that other methods of combining the network models into combined network models may be used in other embodiments, and the illustrative methods for combining network models described above are not meant to be limiting.

Still referring to FIG. 2, the system receives as inputs the combined network model 205 along with an output from a random number generator module 206 that generates random numbers. This input is processed by a network architecture builder module 207 which automatically builds two artificial neural network architectures A1 and A2 208 and 209. All nodes and interconnects that are not connected to other nodes and interconnects in the built artificial neural network architectures 208 and 209 are removed. In an embodiment, this removal process is performed by propagating through the artificial neural networks and marking all nodes and interconnects that are not connected to other nodes and interconnects and then removing the marked nodes and interconnects, but this is not meant to be limiting and other methods for removal may be used in other embodiments. Based on these artificial neural network architectures 208 and 209 automatically built by the network architecture builder module 207, new artificial neural networks 210 and 211 may be built and trained for the task of object recognition from images or video. In an embodiment, the artificial neural networks 210 and 211 are trained based on the desired bit-rates of interconnect weights in the artificial neural networks, such as 32-bit floating point precision, 16-bit floating point precision, 32-bit fixed point precision, 8-bit integer precision, and 1-bit binary precision. All interconnects with interconnect weights equal to 0 and all nodes that are not connected to other nodes and interconnects are removed from trained artificial neural networks 210 and 211. In an embodiment, this removal process is performed by propagating through the artificial neural networks and marking interconnects that have interconnect weights equal to 0 and all nodes that are not connected to other nodes and interconnects and then removing the marked nodes and interconnects, but this is not meant to be limiting and other methods for removal may be used in other embodiments. In an iterative process, the new trained artificial neural networks 210 and 211 are then used to construct two new network models. This building process can be repeated to build different artificial neural network architectures based on previous artificial neural network architectures. The trained artificial neural networks constructed using the automatically built artificial neural network architectures can then be used in an object recognition system 212.

To illustrate the utility of the above described system and method in a practical sense, the above described system optimized for object recognition from image and video was built and tested for recognition of one or more abstract objects or a class of abstract objects, such as recognition of alphanumeric characters from images. Experiments using this illustrative embodiment of the invention on the MNIST benchmark showed that the present system was able to automatically build new artificial neural networks with forty times fewer interconnects than the initial input artificial neural networks, yet yielding trained artificial neural networks with a recognition accuracy of 99%, which is on par with state-of-the-art artificial neural network architectures that were hand-crafted by human experts. Furthermore, experiments using this specific embodiment showed that it was also able to automatically build new artificial neural networks with 106 times fewer interconnects than the initial input trained artificial neural networks, yet still yielding trained artificial neural networks with a recognition accuracy of 95%. This significant reduction in interconnects can be especially important for building integrated circuit chip embodiments of an artificial neural network, as aspects such as memory size, cost, and power consumption can be reduced.

To further illustrate the utility of the above described system and method in a practical sense, the above described system optimized for object recognition from image and video was built and tested for recognition of one or more physical objects or a class of physical objects from natural images, whether unique or within a predefined class. Experiments using this illustrative embodiment of the invention on the STL-10 benchmark showed that the present system was able to automatically build new artificial neural networks with fifty times fewer interconnects than the initial input trained artificial neural networks, yet yielding trained artificial neural networks with a recognition accuracy of 64%, which is higher than the initial input training artificial neural networks which had recognition accuracy of 58%. Furthermore, experiments using this specific embodiment for object recognition from natural images showed that it was also able to automatically build new artificial neural networks that had 100 times fewer interconnects than the initial input trained artificial neural networks, yet still yielding trained artificial neural networks with a recognition accuracy of 60%.

These experimental results show that the presented system and method can be used to automatic build new artificial neural networks that enable highly practical machine intelligence tasks, such as object recognition, with reduced human input.

Now referring to FIG. 3 shown is a schematic block diagram of a generic computing device that may provide a suitable operating environment in one or more embodiments. A suitably configured computer device, and associated communications networks, devices, software and firmware may provide a platform for enabling one or more embodiments as described above. By way of example, FIG. 3 shows a generic computer device 300 that may include a central processing unit (“CPU”) 302 connected to a storage unit 304 and to a random access memory 306. The CPU 302 may process an operating system 301, application program 303, and data 323. The operating system 301, application program 303, and data 323 may be stored in storage unit 304 and loaded into memory 306, as may be required. Computer device 300 may further include a graphics processing unit (GPU) 322 which is operatively connected to CPU 302 and to memory 306 to offload intensive image processing calculations from CPU 302 and run these calculations in parallel with CPU 302. An operator 310 may interact with the computer device 300 using a video display 308 connected by a video interface 305, and various input/output devices such as a keyboard 310, pointer 312, and storage 314 connected by an I/O interface 309. In known manner, the pointer 312 may be configured to control movement of a cursor or pointer icon in the video display 308, and to operate various graphical user interface (GUI) controls appearing in the video display 308. The computer device 300 may form part of a network via a network interface 311, allowing the computer device 300 to communicate with other suitably configured data processing systems or circuits. A non-transitory medium 316 may be used to store executable code embodying one or more embodiments of the present method on the generic computing device 300.

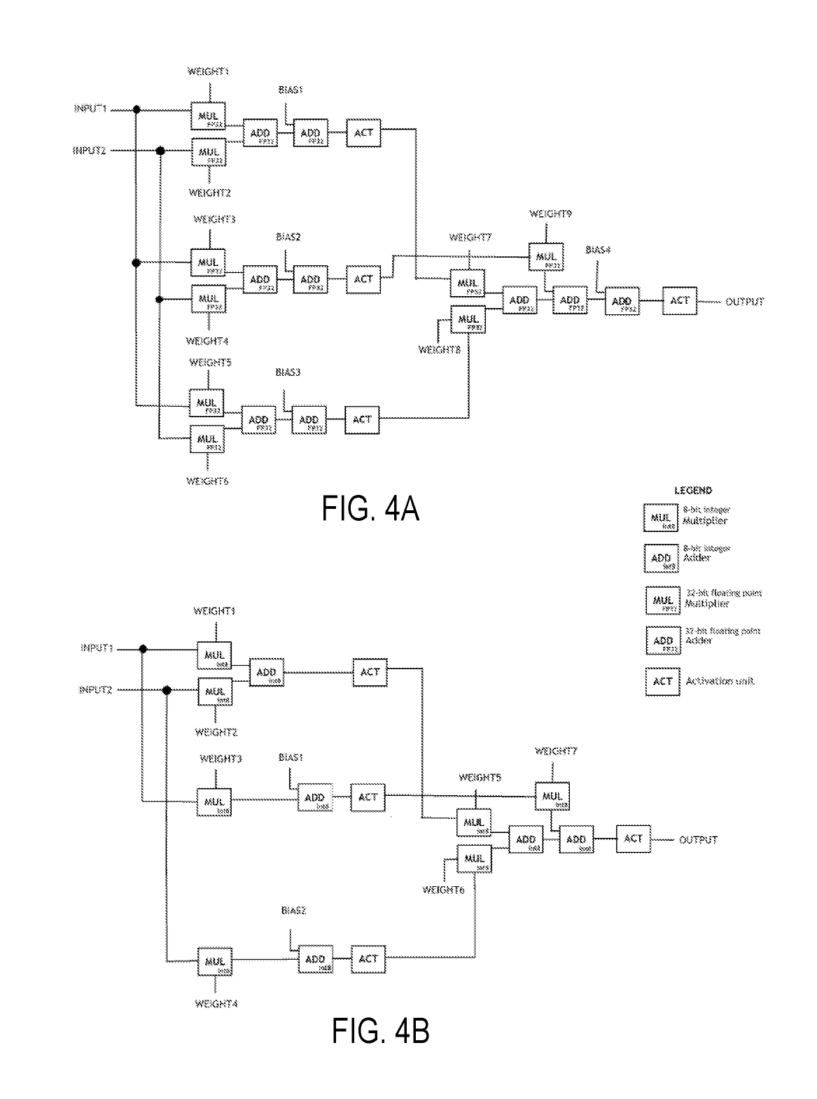

Now referring to FIGS. 4A and 4B, shown are schematic block diagrams of an illustrative integrated circuit with a plurality of electrical circuit components used to build an unoptimized artificial neural network architecture (FIG. 4A), and an integrated circuit embodiment with an optimized artificial neural network architecture built in accordance with the present system and method (FIG. 4B).

The integrated circuit embodiment shown in FIG. 4B with a network architecture built in accordance with the present system and method requires two fewer multipliers, four fewer adders, and two fewer biases compared to the integrated circuit of an unoptimized network architecture. Furthermore, while the integrated circuit with an unoptimized network architecture of FIG. 4A comprises 32-bit floating point adders and multipliers, the integrated circuit embodiment with an artificial neural network architecture built in accordance with the present system and method comprises 8-bit integer adders and multipliers which are faster and less complex. This illustrates how the present system and method can be used to build artificial neural networks that have less complex and more efficient integrated circuit embodiments. As an illustrative application, the present system and method can be utilized to build artificial neural networks with significantly fewer interconnects and nodes for tasks such as vehicle license plate recognition, such that an integrated circuit embodiment of the optimized artificial neural network can be integrated into a traffic camera with high speed, low cost and low energy requirements.

Thus, in an aspect, there is provided a computer-implemented method of building an artificial neural networks for a given task, comprising: (i) constructing, utilizing a processor, one or more network models based on properties of one or more artificial neural networks and one or more desired artificial neural network architecture properties, the one or more network models defining probabilities of one or more nodes and/or interconnects from a set of possible nodes and interconnects existing in a given artificial neural network; (ii) combining, utilizing a model combiner module, the one or more network models into combined network models; (iii) generating, utilizing a random number generator module, random numbers; (iv) building, utilizing a network architecture builder module, one or more new artificial neural network architectures based on combined network models and the random numbers generated from the random number generator module; (v) building one or more artificial neural networks based on the new artificial neural network architectures built by the network architecture builder module; and (vi) training one or more artificial neural networks built based on the new artificial neural network architectures.

In an embodiment, the method further comprises generating, utilizing a processor, one or more subsequent network models based on properties of one or more artificial neural networks and one or more desired artificial neural network architecture properties; and repeating the steps to iteratively build new artificial neural network architectures.

In another embodiment, the method further comprises storing the iteratively learned knowledge on how to build new artificial neural network architectures, thereby to build future artificial neural network architectures based on past neural network architectures.

In another embodiment, the method further comprises training one or more artificial neural networks built based on the new artificial neural network architectures and desired bit-rates of interconnect weights in the one or more artificial neural networks.

In another embodiment, wherein building one or more new artificial neural network architectures comprises removing all nodes and interconnects that are not connected to other nodes and interconnects in the one or more new artificial neural network architectures.

In another embodiment, building one or more new artificial neural network architectures comprises removing all interconnects that have interconnect weights equal to 0 and all nodes that are not connected to other nodes and interconnects in the trained artificial neural networks.

In another embodiment, the given task is object recognition from images or video, and the method further comprises building one or more artificial neural networks trained for the task of object recognition from images or video.

In another embodiment, the given task of object recognition from images or video comprises recognition of one or more predefined abstract objects or a class of predefined abstract objects.

In another embodiment, the given task of object recognition from images or video comprises recognition of one or more predefined physical objects or a class of predefined physical objects.

In another embodiment, the one or more predefined physical objects comprise one or more identifiable biometric features or a class of biometric features.

In another aspect, there is provided a computer-implemented system for building an artificial neural network for a given task, the system comprising a processor and a memory, and adapted to: (i) construct, utilizing a processor, one or more network models based on properties of one or more artificial neural networks and one or more desired artificial neural network architecture properties, the one or more network models defining probabilities of one or more nodes and/or interconnects from a set of possible nodes and interconnects existing in a given artificial neural network; (ii) combine, utilizing a model combiner module, the one or more network models into combined network models; (iii) generate, utilizing a random number generator module, random numbers; (iv) build, utilizing a network architecture builder module, one or more new artificial neural network architectures based on combined network models and the random numbers generated from the random number generator module; (v) build one or more artificial neural networks based on the new artificial neural network architectures built by the network architecture builder module; and (vi) train one or more artificial neural networks built based on the new artificial neural network architectures.

In an embodiment, the system is further adapted to generate, utilizing a processor, one or more subsequent network models based on properties of one or more trained artificial neural networks and one or more desired artificial neural network architecture properties; and repeat (ii) to (vi) to iteratively build new artificial neural network architectures.

In another embodiment, the system is further adapted to store the iteratively learned knowledge on how to build new artificial neural network architectures, thereby to build future artificial neural network architectures based on past neural network architectures.

In another embodiment, the system is further adapted to train one or more artificial neural networks built based on the new artificial neural network architectures and desired bit-rates of interconnect weights in the one or more artificial neural networks.

In another embodiment, the system is further adapted to remove all nodes and interconnects that are not connected to other nodes and interconnects in the one or more new artificial neural network architectures when building one or more new artificial neural network architectures.

In another embodiment, the system is further adapted to remove all interconnects that have interconnect weights equal to 0 and all nodes that are not connected to other nodes and interconnects in the trained artificial neural networks when building one or more new artificial neural network architectures.

In another embodiment, for the given task of object recognition from images or video, the system is further adapted to build one or more artificial neural networks trained for the task of object recognition from images or video.

In another embodiment, the given task of object recognition from images or video comprises recognition of one or more predefined abstract objects or a class of predefined abstract objects.

In another embodiment, the given task of object recognition from images or video comprises recognition of one or more predefined physical objects or a class of predefined physical objects.

In another embodiment, the one or more predefined physical objects comprise one or more identifiable biometric features or a class of biometric features.

In another aspect, there is provided an integrated circuit having a plurality of electrical circuit components arranged and configured to replicate the nodes and interconnects of the artificial neural network architecture built by the present system and method.

While illustrative embodiments have been described above by way of example, it will be appreciated that various changes and modifications may be made without departing from the scope of the invention, which is defined by the following claims.

1. A computer-implemented method of building an artificial neural network architecture for a given task, comprising:
(i) constructing, utilizing a processor, one or more network models based on properties of one or more artificial neural networks and one or more desired artificial neural network architecture properties, the one or more network models defining probabilities of one or more nodes and/or interconnects from a set of possible nodes and interconnects existing in a given artificial neural network;
(ii) combining, utilizing a model combiner module, the one or more network models into combined network models;
(iii) generating, utilizing a random number generator module, random numbers;
(iv) building, utilizing a network architecture builder module, one or more new artificial neural network architectures based on the combined network models and the random numbers generated from the random number generator module;
(v) building one or more artificial neural networks based on the new artificial neural network architectures built by the network architecture builder module; and
(vi) training one or more artificial neural networks built based on the new artificial neural network architectures.

2. The computer-implemented method of claim 1, further comprising:
(vii) generating, utilizing a processor, one or more subsequent network models based on properties of one or more artificial neural networks and one or more desired artificial neural network architecture properties; and
(viii) repeating steps (ii) to (vi) to iteratively build new artificial neural network architectures.

3. The computer-implemented method of claim 2, further comprising:
(ix) storing the iteratively learned knowledge on how to build new artificial neural network architectures, thereby to build future artificial neural network architectures based on past neural network architectures.

4. The computer-implemented method of claim 1, further comprising:
(x) training one or more artificial neural networks built based on the new artificial neural network architectures and desired bit-rates of interconnect weights in the one or more artificial neural networks.

5. The computer-implemented method of claim 1, wherein building one or more new artificial neural network architectures in step (iv) comprises removing all nodes and interconnects that are not connected to other nodes and interconnects in the one or more new artificial neural network architectures.

6. The computer-implemented method of claim 1, wherein building one or more new artificial neural network architectures in step (iv) comprises removing all interconnects that have interconnect weights equal to 0 and all nodes that are not connected to other nodes and interconnects in the trained artificial neural networks.

7. The computer-implemented method of claim 1, wherein the given task is object recognition from images or video, and the method further comprises building one or more artificial neural networks trained for the task of object recognition from images or video.

8. The computer-implemented method of claim 7, wherein the given task of object recognition from images or video comprises recognition of one or more predefined abstract objects or a class of predefined abstract objects.

9. The computer-implemented method of claim 7, wherein the given task of object recognition from images or video comprises recognition of one or more predefined physical objects or a class of predefined physical objects.

10. The computer-implemented method of claim 7, wherein the one or more predefined physical objects comprise one or more identifiable biometric features or a class of biometric features.

11. A computer-implemented system for building an artificial neural network architecture for a given task, the system comprising a processor and a memory, and adapted to:
(i) construct, utilizing a processor, one or more network models based on properties of one or more artificial neural networks and one or more desired artificial neural network architecture properties, the one or more network models defining probabilities of one or more nodes and/or interconnects from a set of possible nodes and interconnects existing in a given artificial neural network;
(ii) combine, utilizing a model combiner module, the one or more network models into combined network models;
(iii) generate, utilizing a random number generator module, random numbers;
(iv) build, utilizing a network architecture builder module, one or more new artificial neural network architectures based on combined network models and the random numbers generated from the random number generator module;
(v) build one or more artificial neural networks based on the new artificial neural network architectures built by the network architecture builder module; and
(vi) train one or more artificial neural networks built based on the new artificial neural network architectures.

12. The computer-implemented system of claim 11, wherein the system is further adapted to:
(vii) generate, utilizing a processor, one or more subsequent network models based on properties of one or more artificial neural networks and one or more desired artificial neural network architecture properties; and
(viii) repeat (ii) to (vi) to iteratively learn build new artificial neural network architectures.

13. The computer-implemented system of claim 12, wherein the system is further adapted to:
(ix) store the iteratively learned knowledge on how to build new artificial neural network architectures, thereby to build future artificial neural network architectures based on past neural network architectures.

14. The computer-implemented system of claim 11, wherein the system is further adapted to:
(x) train one or more artificial neural networks built based on the new artificial neural network architectures and desired bit-rates of interconnect weights in the one or more artificial neural networks.

15. The computer-implemented system of claim 11, wherein the system is further adapted to remove all nodes and interconnects that are not connected to other nodes and interconnects in the one or more new artificial neural network architectures when building one or more new artificial neural network architectures.

16. The computer-implemented system of claim 11, wherein the system is further adapted to remove all interconnects that have interconnect weights equal to 0 and all nodes that are not connected to other nodes and interconnects in the trained artificial neural networks when building one or more new artificial neural network architectures.

17. The computer-implemented system of claim 11, wherein, for the given task of object recognition from images or video, the system is further adapted to build one or more artificial neural networks trained for the task of object recognition from images or video.

18. The computer-implemented system of claim 17, wherein the given task of object recognition from images or video comprises recognition of one or more predefined abstract objects or a class of predefined abstract objects.

19. The computer-implemented system of claim 17, wherein the given task of object recognition from images or video comprises recognition of one or more predefined physical objects or a class of predefined physical objects.

20. The computer-implemented system of claim 17, wherein the one or more predefined physical objects comprise one or more identifiable biometric features or a class of biometric features.

21. An integrated circuit having a plurality of electrical circuit components arranged and configured to replicate the nodes and interconnects of the artificial neural network architecture built by the system of claim 11.
